(19) United States
(12) Patent Application Publication
(10) Pub. No.: US 2013/0282773 A1
(43) Pub. Date: Oct. 24, 2013

(54) DRIVING INFORMATION STORAGE SYSTEM AND METHOD USING FILE FORMAT TRACK

(71) Applicant: CORE LOGIC INC., Seoul (KR)

(72) Inventor: Jungchan LEE, Seoul (KR)

(21) Appl. No.: 13/848,127

(22) Filed: Mar. 21, 2013

(30) Foreign Application Priority Data
Mar. 21, 2012 (KR) 10-2012-0028931

(51) Int. Cl. G06F 17/30

(52) U.S. Cl. CPC G06F 17/30076
USPC 707/821

(57) ABSTRACT

Embodiments of the invention relate to a method and system for storing driving information in a black box system for vehicles, and more particularly, to driving information storage system and method using a file format track, which can store vehicle driving information input from devices such as a GPS or a G-sensor while maintaining a file format of video or audio data. The driving information storage method includes: receiving vehicle driving information; converting the received driving information into text data; encoding video data input through a camera; encoding audio data input through a microphone; generating a text track in a file format for recording and storing video data and audio data; and recording the text data, a size of the text data, and a time stamp in the text track.

### CROSS-REFERENCE TO RELATED APPLICATION

This application claims priority to Korean Patent Application No. 10-2012-0028931 filed on 21 Mar., 2012, and all the benefits accruing therefrom under 35 U.S.C. §119, the contents of which is incorporated by reference in its entirety.

### BACKGROUND

1. Technical Field

The present invention relates to a method and system for storing driving information in a black box system for vehicles, and more particularly, to a driving information storage system and method using a file format track, which can store vehicle driving information input from devices, such as a global positioning system (GPS) or a G-sensor, while maintaining a file format of video or audio data.

2. Description of the Related Art

As generally known in the art, a black box for a vehicle photographs an accident situation using small cameras disposed on front and rear windshields of the vehicle, and collects and stores audio data collected by a microphone in a storage medium, for example, a memory card. The black box normally records situations relating to driving of the vehicle for durations secured by the storage medium. The black box is operated as soon as the vehicle is started, and in the case of an accident, that is, if impact is applied to the vehicle, driver's voice, impact sounds, operating situations of an accelerator, a vehicle speed, a time point, and the like are recorded in the storage medium in detail.

FIG. 1 is a block diagram of a black box system for vehicles in the related art.

Referring to FIG. 1, the black box system includes sensors 14, 16 for detecting a vehicle speed, external impact, and the like, a front camera 11 for photographing a forward side of the vehicle, a rear camera 12 for photographing a rearward side of the vehicle, and a black box 18 for storing vehicle driving information.

The black box 18 includes video encoder 20, video sensor 22 and video decoder 24 which control input and output of video signals by the front and rear cameras 11, 12 and decode or encode the input and output video signals; a microcomputer 28 which controls overall operation of the black box 18; a driving data memory 30 which stores driving situations photographed by the front and rear cameras as video signals for a predetermined period of time set based on a current time by a timer 34; and a video memory 26 which decompresses current video signals recorded in a compressed state in the driving data memory 30 and stores the decompressed video signals.

Further, the black box 18 includes a display unit 44 for displaying video signals stored in the drive data memory 30 and the video memory 26, and an input interface unit 32 for inputting signals of the speed sensor 14 and the impact sensor 16, the vehicle mechanism input signal and the key detection signal to the microcomputer 28.

Normally, the driving data memory 30 repeatedly performs an operation of storing and removing driving conditions of the vehicle at predetermined intervals, and stores a driving condition before and after an accident according to a signal from an impact sensor when the accident occurs.

Such a black box system for vehicles is disclosed in detail in Korean Patent Application No. 1996-000465 entitled “Black Box System for Vehicle”.

In the art, a black box system generally records video and audio data, and other data such as driving information in a storage medium according to two methods as shown in FIGS. 2a and 2b.

FIG. 2a shows one example in which driving information data (information related to a GPS and a G-sensor) are present in the same file as that of video and audio data, and a file format f2 for recording driving information data is different from a file format f1 for recording video and audio data.

FIG. 2b shows one example in which a file 30a for recording video and audio data and a file 30b for recording driving information data are separately provided and file formats f3 and f4 are different from each other.

As shown in FIGS. 2a and 2b, when video, audio, and driving information data are recorded together in the storage medium of the black box, separate file formats are used for storage (FIG. 2a) or different files are used for storage (FIG. 2b).

As apparent to those skilled in the art, since the file formats in which video and/or audio data are recorded are supported by an existing common reproducer, the stored images and sound can be confirmed anywhere.

However, as shown in FIGS. 2a and 2b, when video and audio data and driving information data are stored together, the video and audio data can be supported by an existing common reproducer, but the driving information data are not supported by the common reproducer, so a dedicated reproducer needs to be added.

### BRIEF SUMMARY

An aspect of the present invention is to provide a driving information storage system and method using a file format track, which can store driving information data and audio data together while maintaining a file format for recording video and audio data.

In accordance with one aspect of the invention, a driving information storage system using a file format track of a black box system for vehicles includes: a vehicle driving information reception unit which receives vehicle driving information; a text data generator which converts the vehicle driving information received by the vehicle driving information reception unit to be output as text data; a video encoder which encodes video driving information input through a camera; an audio encoder which encodes audio driving information input through a microphone; and a data integration unit which integrates text data output from the text data generator with video data output from the video encoder and audio data output from the audio encoder into one file format to record and store the text data, the video data and the audio data in the file format.

The vehicle driving information may include at least one of GPS information, G-sensor information, and brake information.

The text data generator may create a text track in the one file recording and storing the video data and the audio data, and may record the text data, a size of the text data and a time stamp of the text data in the text track.

In accordance with another aspect of the invention, a driving information storage method includes: receiving vehicle driving information; converting the received driving information into text data; encoding video data input through a camera; encoding audio data input through a microphone; generating a text track in a file format for recording and storing video data and audio data; and recording the text data, a size of the text data, and a time stamp in the text track.

According to the present invention, since the method and apparatus can transform vehicle driving information into text (character) data to be stored together with video and audio data in one file format, there is no need for increasing the number of storage files, thereby improving reliability in file management. In addition, the method and apparatus of the present invention allows the vehicle driving information stored together with video and audio data to be confirmed by a common reproducer, thereby improving user convenience.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a block diagram of a black box system for vehicles in the related art;

FIG. 2a is a view of a text data storage (input) method applied to a black box system in the related art;

FIG. 2b is a view of another text data storage (input) method applied to a black box system in the related art;

FIG. 3 is a block diagram of a driving information storage system using a file format track of a black box system for vehicles according to one embodiment of the present invention;

FIG. 4 is an exemplary view of a text data storage (input) method according to one embodiment of the present invention; and

FIG. 5 is a flowchart of a driving information storage method using a file format track of a black box system for vehicles according to one embodiment of the present invention.

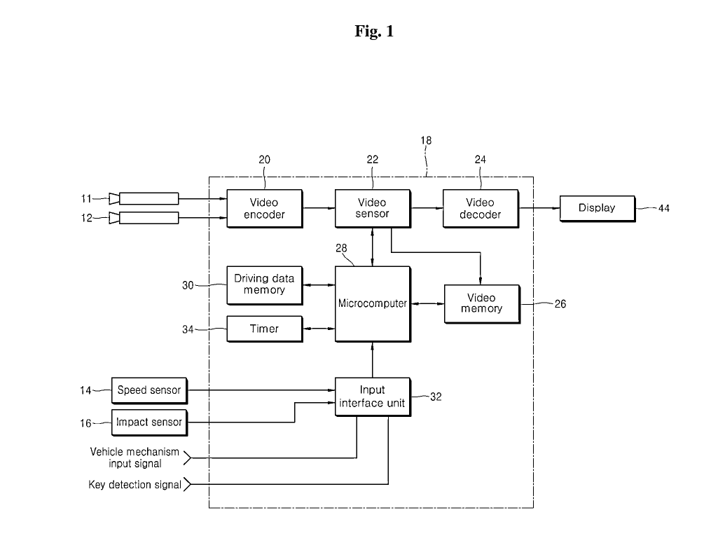

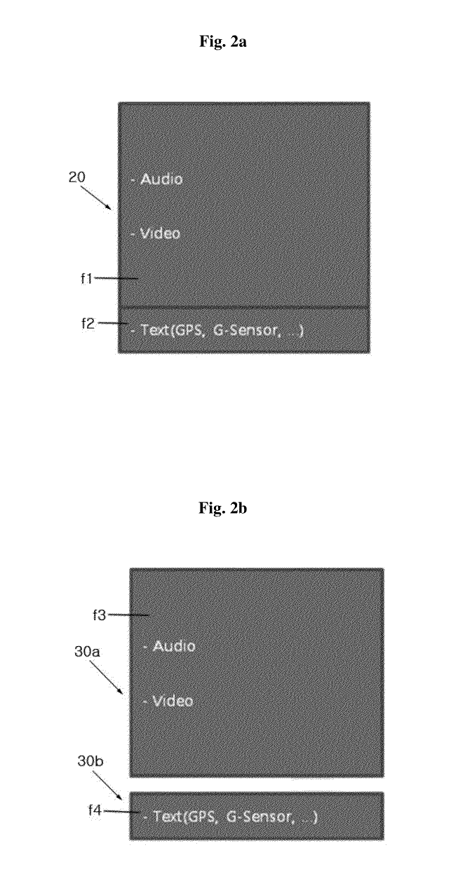

### DETAILED DESCRIPTION

Embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity.

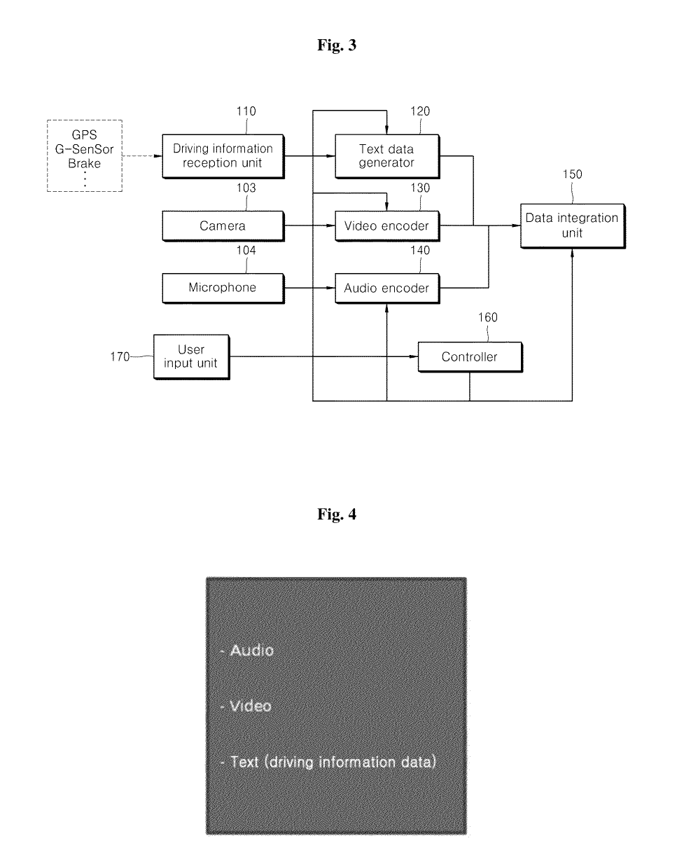

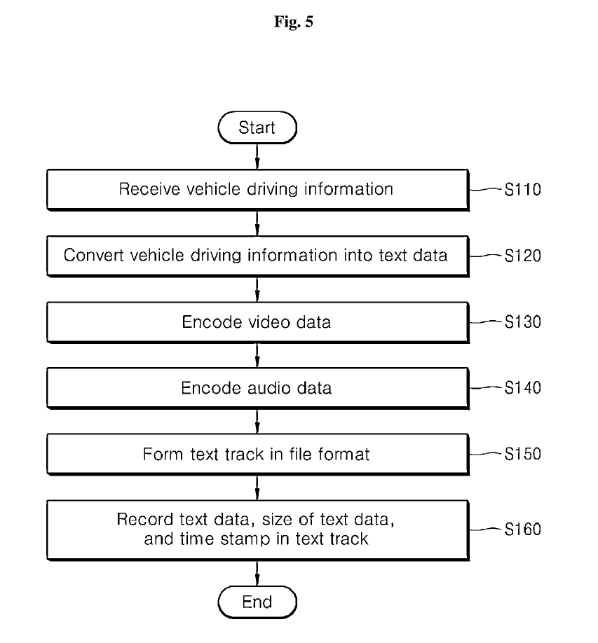

FIG. 3 is a block diagram of a driving information storage system using a file format track of a black box system for vehicles according to one embodiment of the present invention, and FIG. 4 is an exemplary view of a text data storage (input) method according to one embodiment of the present invention.

Referring to FIGS. 3 and 4, a driving information storage system according to one embodiment may include a vehicle driving information reception unit 110 which receives vehicle driving information (for example, GPS information, G-sensor information, brake information, and the like); a text data generator 120 which converts the vehicle driving information received by the vehicle driving information reception unit 110 to be output into text (character) data; a video encoder 130 which encodes video driving information input through a camera 103; an audio encoder 140 which encodes audio driving information input through a microphone 104; a data integration unit 150 which integrates the text data output from the text data generator 120 with the video data output from the video encoder 130 and the audio data output from the audio encoder 140 into one file format to record and store the same in the file format.

In addition, the driving information storage system may further include a user input unit 170 through which a user manipulates the black box system, and a controller 160 for controlling the text data generator, the video encoder, the audio encoder, and the data integration unit 120, 130, 140, 150 constituting the driving information storage system.

In the present invention, the vehicle driving information may include at least one of GPS information, G-sensor information, and brake information, and the driving information reception unit 110 may receive the driving information from at least one of a GPS, a G-sensor, and a brake in the vehicle.

The text data generator 120 generates a text track in a file format for recording video data and audio data and records the text data, a size of the text data, and a time stamp in the text track. The container format for recording the video data and the audio data may be AVI or MP4.

FIG. 6 is a flowchart of a driving information storage method using a file format track of the black box system for vehicles according to one embodiment of the present invention.

Next, a driving information storage method according to one embodiment will be described with reference to FIGS. 3 and 5.

The method of storing vehicle driving information may include receiving vehicle driving information (S110); converting the received driving information into text data (S120); encoding video data input through a camera (S130); encoding audio data input through a microphone (S140); generating a text track in a file format which records and stores video data and audio data (S150); and recording the text data, a size of the text data, and a time stamp in the text track (S160).

If vehicle driving information such as a GPS signal, a G-sensor signal, and a brake signal is input to the driving information receiver 110 upon operation of a black box system for vehicles (S110), the controller 160 may control the text data generator 120 to convert the driving information input to the driving information receiver 110 into text data.

The text data generator 120 may convert the driving information into the text data under control of the controller 160 (S120).

Operating conditions of the black box system are operation conditions of a general black box system, and corresponds to situations (S130 and S140) in which video and audio data are obtained through the camera 103 and the microphone 104 and are encoded through the video encoder 130 and the audio encoder 140. Here, since such operation of the black boxy system is well known to those skilled in the art, detailed descriptions thereof will be omitted.

If the vehicle driving information received by the text data generator 120 is text data, the controller 160 controls the data integration unit 150 to create a caption (text) track in a container format (for example, AVI and MP4) for recording video data and audio data (S150).

When the text track is formed (S150), the controller 160 controls the data integration unit 150 to record the text data, a size of the text data, and a time stamp in the text track (S160).

A form in which all of the video, audio and text data are recorded in S160 is shown in FIG. 4.

Instead of being separately stored in an internal memory of the black box system, the text data may be recorded in the file format together with the video data and the audio data though the data integration unit 150, as shown in FIG. 4. Accordingly, when the stored file is reproduced, the text data can also be reproduced through a common reproducer, that is, an existing reproducer for reproducing video and audio data, thereby improving convenience in use of the black box system.

It is apparent that the driving information storage method of the black box system may be performed through an automated procedure according to a time-based sequence by a software program installed in storage media. Codes and code segments of the program may be easily deduced by a computer programmer in the art. In addition, the program is stored in computer readable media and is read and executed by a computer to implement the driving information storage method. The storage media include magnetic recording media, optical recording media, and carrier wave media.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A driving information storage system using a file format track, comprising:
a video encoder which encodes video driving information input through a camera to output video data;
an audio encoder which encodes audio driving information input through a microphone to output audio data;
a text data generator which receives vehicle driving information to generate text data; and
a data integration unit which records and stores the text data in one file format in which the video data and the audio data are stored.

2. The driving information storage system according to claim 1, wherein the vehicle driving information comprises at least one of GPS information, G-sensor information, and brake information.

3. The driving information storage system according to claim 1, wherein the text data generator generates a text track in the one file and records the text data in the text track.

4. The driving information storage system according to claim 3, wherein the text data generator records a size of the text data together with the text data in the text track.

5. The driving information storage system according to claim 3, wherein the text data generator records a time stamp of the text data together with the text data in the text track.

6. A driving information storage method using a file format track, comprising:
receiving vehicle driving information;
generating a text track in a file format for recording and storing video data and audio data; and
recording and storing the text data in the text track.

7. The driving information storage method according to claim 6, wherein the recording and storing the text data comprises recording and storing a size of the text data together in the text track.

8. The driving information storage method according to claim 6, wherein the recording and storing the text data comprises recording and storing a time stamp of the text data together in the text track.

9. The driving information storage method according to claim 6, further comprising:
encoding an image input through a camera and outputting the video data; and
encoding an audio input through a microphone and outputting the audio data.

10. The driving information storage method according to claim 6, wherein the vehicle driving information comprises at least one of GPS information, G-sensor information, and brake information.
